(19) United States
(12) Patent Application Publication
(10) Pub. No.: US 2023/0028601 A1
(43) Pub. Date: Jan. 26, 2023

(54) METHOD AND ARRANGEMENT FOR TREATING A MINERAL SOLID MIXTURE

(71) Applicants: Christoph STRAETMANS, Wippershain (DE); GRENZEBACH BSH GmbH, Bad Hersfeld (DE)

(72) Inventors: Christoph STRAETMANS, Wippershain (DE); Thorsten REHBOCK, Hauneck (DE); Günther SCHÄFER, Neuenstein-Obergeis (DE); Sebastian LICHT, Hauneck (DE)

(73) Assignee: GRENZEBACH BSH GmbH, Bad Hersfeld (DE)

(21) Appl. No.: 17/779,942

(22) PCT Filed: Nov. 26, 2020
(86) PCT No.: PCT/EP2020/000203

§ 371 Date: May 25, 2022

(30) Foreign Application Priority Data
Nov. 26, 2019 (DE) 10 2019 008 187.0

(51) Int. Cl. C10C 3/00; C08L 95/00; F23G 7/06; B09B 3/40

(52) U.S. Cl. CPC C10C 3/007; C08L 95/00; F23G 7/06; B09B 3/40; C08L 2555/34; E01C 19/1004

(57) ABSTRACT

A method of processing a mineral solid mixture, in particular road construction material, containing impurities with aromatic and/or aliphatic hydrocarbons, wherein the solid mixture is heated to a temperature below 570° C., wherein the solid mixture is heated in at least one heated rotating drum-like apparatus and is passed through at least one container and that the solid mixture is heated during or after the heating process, drum-like apparatus and is passed through at least one container, and in that the solid mixture is subjected to a negative pressure during heating or after heating, and in that the hydrocarbons are extracted from the heated solid mixture by the negative pressure and are rendered harmless by thermal combustion.

The invention relates to a method for treating a mineral solid mixture, in particular road demolition material, containing impurities with aromatic and/or aliphatic hydrocarbons, wherein the solid mixture is heated to a temperature below 570° C. Similarly, the invention also relates to an arrangement for treating a mineral solid mixture, in particular road demolition material.

Asphalt represents the most important construction material for road construction.

When used asphalt, e.g. road demolition material, is to be recycled into new asphalt by heating and subsequent mixing, the problem arises that only used asphalt of sufficiently high quality can be used. If low quality asphalt is used, it will lead to a deterioration in the quality of the recycled asphalt product. First of all, it should be noted that recycling of asphalt is not possible if it contains harmful components such as pitch or tar. Asphalt containing tar and pitch has been used until the last decade of the twentieth century. Asphalt containing tar has the disadvantage of containing, among other substances, polycyclic aromatic hydrocarbons (PAHs), which are harmful substances that are now subject to strict legal restrictions. It is not permitted to recycle asphalt containing tar by hot mixing it with new asphalt because the PAHs could then escape into the environment. Asphalt waste containing PAHs above the permissible limit may no longer be put into circulation untreated according to the latest legal requirements. In compliance with the Closed Substance Cycle Waste Management Act, such waste should preferably be subjected to thermal treatment in order to remove the harmful PAH constituents in this way or to reduce them to a level below the permissible limit.

A method for recycling tar contained in asphalt is already known from DE 600 10 533 T2. In this method, a material containing asphalt aggregate is thermally converted into a mineral residue and hot gases. The hot gases are fed to an asphalt mixing plant.

DE 23 65 087 A1 discloses a plant for the production of asphalt materials containing rocks using a mixer and a rotary kiln in which a vacuum is maintained. From the rotary kiln, the material passes into a cleaner and a collecting container.

DE 34 43 039 A1 describes a method for extracting soluble admixtures from non-soluble bulk materials, in particular for separating bitumen and minerals from bituminous road debris in an extractor, in which solvent is added to the bulk material with constant mixing, the resulting solution is separated from the bulk material, and the bulk material is dried and the soluble constituents are separated from the solvent by distillation, as well as a device for such extraction. The extraction is carried out using negative pressure.

DE 10 2004 055 474 A1 shows a method for the production of bituminous mix using a rotary kiln in which moisture is driven out of the mineral materials and the material is heated to a temperature in the range between 200° C. and 350° C. To produce the mix, an oil-based adduct is added to the asphalt granules.

In the apparatus for cleaning contaminated materials known from EP 1 785 202 A1, a condenser unit comprising a jet scrubber, a condensate collecting vessel for separating the condensate produced at the jet scrubber, a demistor, and a heat exchanger is used.

It is the object of the present invention to provide a resource-saving method for recycling road construction material containing tar and pitch.

Another object of the present invention is to provide a method which permits the recycling of lower quality material containing tar, pitch and/or bitumen, which in particular contains PAHs.

A further object is to recycle tar and/or bitumen containing material in connection with the production of asphalt in such a way that there is a saving of energy and starting materials. It is also an object of the invention to provide a method for recycling asphalt as fully as possible in an effective and economical manner.

The present invention provides a method for the thermal treatment of bulk materials containing harmful substances, in particular for the removal or reduction of the harmful substances from material containing tar, and thus at the same time for the recycling of the mineral material contained therein.

The invention thus provides a method which enables the thermal processing of asphalt at low temperatures, has a low effort for the purification of the escaping gases and vapors, also has a low apparatus effort and, moreover, has a favorable energy consumption as well as low operating costs.

The invention is based on the realization that the asphalt waste to be treated can be heated in one or more steps and extracted by lowering the gas pressure in the container, for example in a rotating drum-shaped apparatus, in particular in a rotary kiln in which it is located, for a defined period of time.

At ambient pressure, the high boiling points of the PAH compounds contained in asphalt in particular make their removal difficult and require relatively high temperatures during treatment. For example, the compound indeno(1,2,3-c,d)pyrene already has a boiling point of 536° C.

According to the invention, the PAH-containing mixture or road construction material is heated, for example, in a first process step at ambient pressure up to a temperature of about 300° C. to 570° C., in order to dissolve a portion of the PAHs out of the material in this way already.

The method according to the invention has the fundamental advantage that the thermal conversion of the tar-containing material proceeds in particular autothermally; this means that the thermal conversion process requires little energy input from outside and therefore leads to a saving of energy in asphalt processing.

The mineral material contained in the tar-containing asphalt, which is an asphalt material or asphalt aggregate, is recycled for use in high-value applications, i.e., in the production of new or recycled asphalt, and therefore results in savings in the feedstock. If the hot gases still contain dust particles, they are removed by the plant's filtration system. The resulting waste gas streams are cleaned by a waste gas purification system, in particular a thermal, regenerative or catalytic afterburning system. The tar-containing material, which includes mineral materials and binders, is fully recycled without further residues. Volatilized polycyclic or other harmful hydrocarbons such as phenols, for example, are burned in the burners; the resulting waste heat is used, for example, to return it to the apparatus and/or a downstream tank, mixer and/or recirculating unit or silo.

To the extent that the unwanted hydrocarbons accumulate in a jet scrubber, they are dissolved in a fluid with which the jet scrubber is operated, for example a liquid hydrocarbon or hydrocarbon mixture such as gasoline, fuel oil or petroleum. Subsequently, the fluid of the jet scrubber enriched with the hydrocarbons extracted from the tar-containing asphalt can be fed to a burner, which in turn heats the container, in particular the drum-type apparatus, and/or another container and/or mixer in which the road construction material is located.

When the jet scrubber is operated with a fluid, a separator is used to separate the accumulated hydrocarbons and any solids from the fluid.

In the present application, the term “recycling” includes the reuse of recovered materials. When “recycling of asphalt” is mentioned, this term includes thermal treatment of asphalt and subsequent use of the residue and energy content for asphalt production, as well as mixing the recovered asphalt together with new mineral aggregate and new bitumen to obtain a new asphalt product (“recycled asphalt”).

The term “asphalt” is understood to include, for example, asphalt that contains at least in part fresh bitumen and that may also contain bitumen from reclaimed asphalt. Thus, this term also includes so-called recycled asphalt, which includes fresh as well as reclaimed mineral materials or stones.

The reuse of reclaimed asphalt containing tar means a substitution of mineral materials or rocks, which significantly contributes to the conservation of natural rock resources.

The quartz contained in the road construction material transforms at a temperature of 573° C. into the modification of high quartz or beta quartz. The method according to the invention therefore operates at temperatures below 570° C. in order to preserve the rock quality of the materials contained in the excavated asphalt and to be able to reuse them without restriction. Likewise, the firing of the clay-containing ingredients must be avoided because, once incorporated in an asphalt layer, they could extract water from it and break up during frost.

This procedure is considerably supported by the use of negative pressure, since the boiling temperatures of the hydrocarbons to be dissolved out of the excavated material are lowered and work can be carried out at lower temperatures. At the same time, less thermal energy has to be used. Depending on the negative pressure, the temperature range at which the hydrocarbons can be dissolved out of the breakout material is considerably reduced, for example to 450° C., preferably to a temperature below 400° C. According to the invention, such a low boiling temperature is achieved if a very low absolute pressure is maintained for a sufficient period of time during and/or after heating of the asphalt containing PAHs. In this way, damage to the mineral composition of the reprocessed material due to excessively high temperatures is avoided.

By reprocessing the road construction material, including the PAH-containing asphalt, close to the point of use, only a small amount of new road construction material, such as crushed rocks, has to be used when renewing an area covered by asphalt, especially during road construction, so that transport costs are saved to a considerable extent, as they would be incurred if PAH-containing asphalt had to be hauled away for deposition in landfills.

Advantageous further embodiments of the invention are apparent from the patent claims and the description, in particular in conjunction with the drawings.

A method according to the invention for processing a mineral solid mixture is characterized in that the solid mixture is heated in at least one rotating drum-like apparatus and is passed through at least one container, and in that the solid mixture is subjected to a negative pressure during the heating or after the heating, and in that the hydrocarbons are extracted from the heated solid mixture with the aid of the negative pressure.

Preferably, the method is characterized in that the solid mixture is heated a second time after passing through the at least one apparatus or that at least the temperature is maintained.

It is advantageous if the solids mixture in the container, in particular a mixer, is heated a further time after passing through the at least one apparatus or is kept at least at the same temperature level.

Preferably, the solids mixture passes through the at least one apparatus at negative pressure. Alternatively, however, the negative pressure is applied to the solid mixture only after it has passed through the at least one apparatus.

For example, and advantageously, the solids mixture passes through the vessel, in particular the mixer or the recirculation unit, also at negative pressure.

Advantageously, the method is practiced by withdrawing at least low-boiling hydrocarbons as gases from the solids mixture, in particular in the at least one apparatus.

The method according to the invention is preferably carried out in such a way that high-boiling hydrocarbons are extracted from the solids mixture after passing through the at least one apparatus in the vessel, in particular in the mixer or the circulation unit.

Preferably, the hydrocarbons, in particular the high-boiling hydrocarbons, are fed to a condenser, in particular a jet scrubber. The vacuum is generated by at least one vacuum pump, in particular by a jet pump. A vacuum pump and a jet pump can also be used in combination.

Advantageously, the jet of the jet scrubber is formed by a combustible fluid in which the high-boiling hydrocarbons are emulsified or get suspended during the washing process.

When the fluid, together with the hydrocarbons in it, is fed to a burner that heats the at least one apparatus and/or the container, in particular the mixer or the recirculation unit, the hydrocarbons extracted from the road debris can be disposed of without leaving any residues that are harmful to the environment.

Preferably, the exhaust gas resulting from the combustion in the burner is directed to the inside of the at least one rotating drum-like apparatus and/or the container, in particular the mixer or the recirculation unit, and/or it heats the apparatus and the container, in particular the mixer, from the outside. Also, depending on the weather, mineral materials that are wet or, for example, not sufficiently dry, can be preheated and/or dried with the exhaust gases before being used in an asphalt mixing plant.

When the hot exhaust gas is introduced into the interior of the apparatus, it promotes the dissolution of hydrocarbons, initially those having a low melting point and boiling point. In this way, already by continuous or batch (discontinuous) introduction of exhaust gases, the proportion of hydrocarbons in the apparatus is reduced, so that then in a downstream vessel, which may also be a rotating drum-like apparatus, further, higher-boiling hydrocarbons are extracted at an even lower negative pressure and, for example, higher temperatures.

The invention also relates to a plant for processing a mineral solid mixture, in particular road demolition material, containing impurities with aromatic and/or aliphatic hydrocarbons, with a combustion device for heating the solid mixture to a temperature below 570° C. The plant is characterized in that it comprises at least one rotating drum-like apparatus, in particular a rotary kiln, and at least one container or mixer arranged downstream of the at least one apparatus in the transport direction of the solids mixture, as well as an arrangement for generating a negative pressure, and in that the solids mixture can be subjected to the negative pressure during heating or after heating.

In particular, it can also be envisaged that at least two such rotating apparatuses, especially rotary kilns, are connected in series. In this case, low-melting and/or boiling hydrocarbons are initially extracted in the first rotary kiln at a temperature which lies, for example, between 200° C. and 250° C., while higher temperatures prevail in the second rotary kiln, for example above 280° C., so that higher-melting and/or higher-boiling hydrocarbons are also extracted there.

In each of the apparatuses, the pressure is adjusted to prevent spontaneous ignition of the hydrocarbons. This is done, for example, by increasing the proportion of an inert gas such as nitrogen in the total gas volume. Lowering the pressure is also provided in accordance with the invention to prevent spontaneous ignition. In this connection, it can be provided, for example, that if several apparatuses are connected in series, the pressure in the processing direction is selected to be lower and lower. Likewise, it can be provided that the temperature in the processing direction is always selected to be higher.

Parallel arrangements of the rotating equipment are particularly suitable if the road construction material to be treated is delivered in batches.

Even in the case of parallel arranged apparatuses, further rotating apparatuses can be arranged downstream of these in each case if the composition of the PAHs contained in the road construction material makes this necessary.

Advantageously, it is provided that the burning apparatus comprises a first burner and that hydrocarbons heated in the at least one apparatus and converted into the gaseous state can be fed to the first burner.

Alternatively, it can be provided that the burning apparatus of the plant comprises a second burner and that hydrocarbons heated in the at least one vessel, in particular a mixer, in gaseous or liquid state, can be supplied to the first burner and/or to a second burner.

In a further advantageous embodiment of the plant, it is provided that it comprises at least one arrangement for dedusting the gaseous hydrocarbons escaping from the at least one apparatus. Where necessary, further devices for exhaust gas after-treatment are provided in accordance with the invention, such as, for example, thermal afterburning, desulfurization and denitrification devices, each of which is arranged downstream of the rotating apparatuses in the treatment direction.

The invention is explained in more detail below in embodiment examples with reference to the drawings. They show:

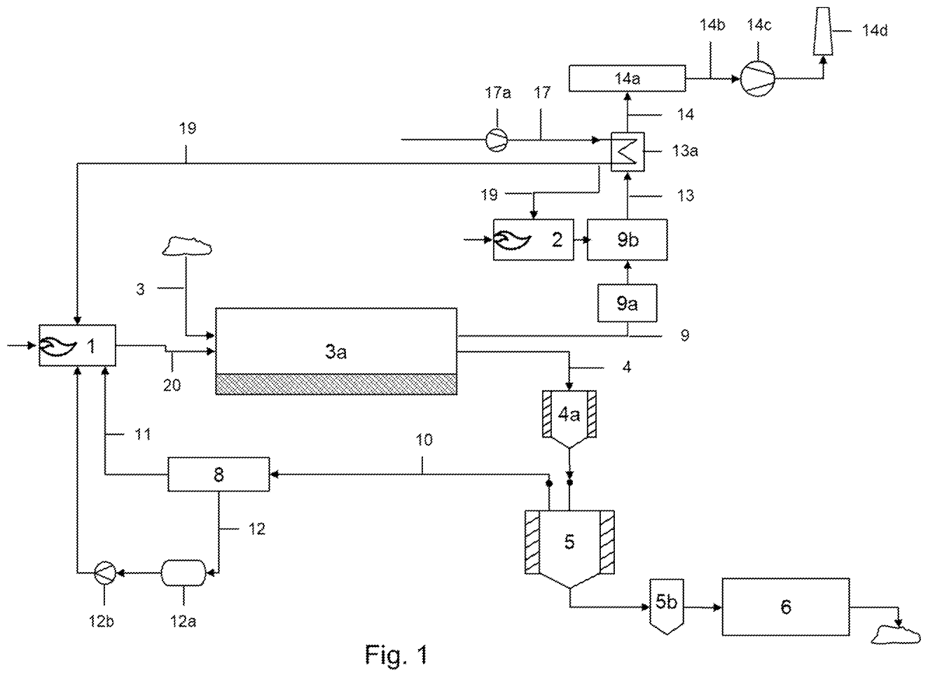

FIG. 1 a schematic representation of a plant for treating a mineral solid mixture in connection with a device for the thermal and/or catalytic post-combustion of waste gases produced in a rotating drum-type apparatus,

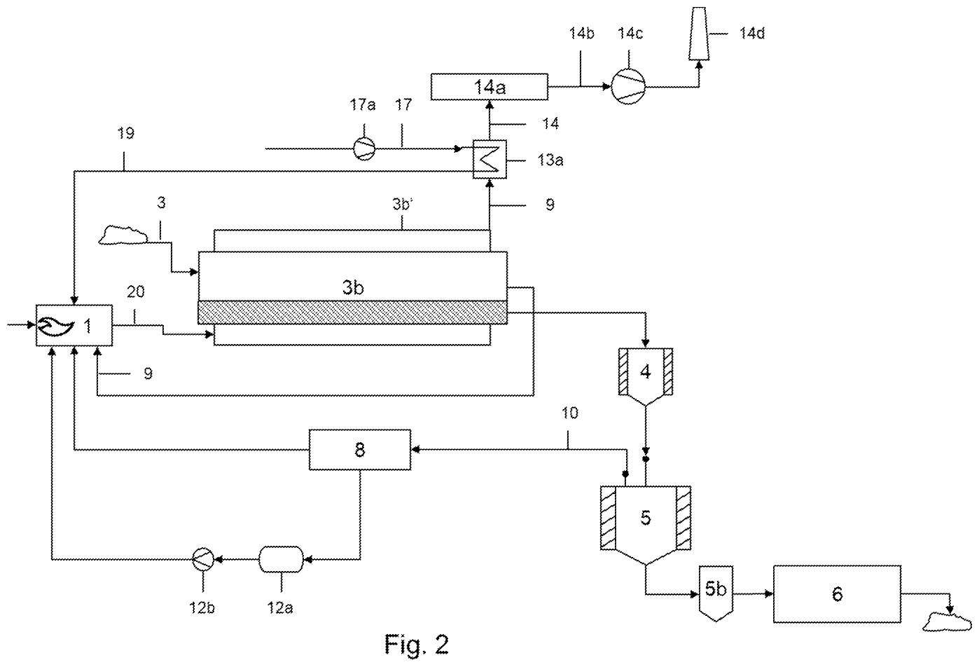

FIG. 2 a schematic representation of a plant which is constructed like the plant shown in FIG. 1, but which does not comprise a device for thermal and/or catalytic afterburning,

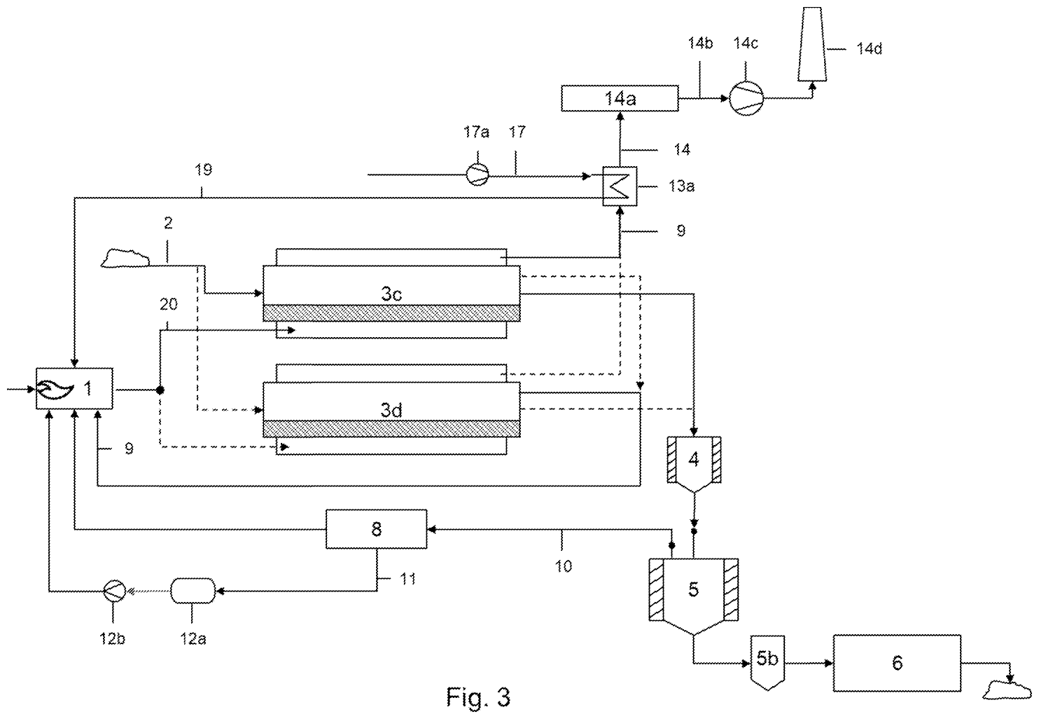

FIG. 3 a schematic representation of a plant comprising two rotating drum-type apparatuses which are alternately fed with road construction material, and

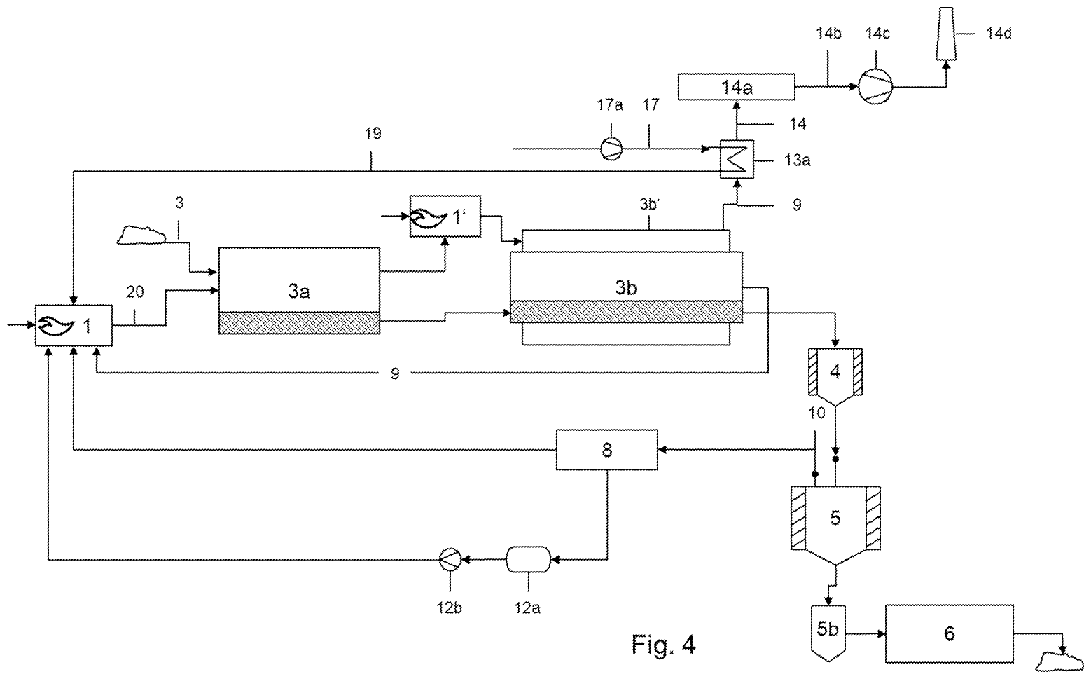

FIG. 4 a schematic representation of a plant with two rotating drum-type apparatuses connected in series.

A fuel, for example fuel oil, is supplied to a burner 1 with a combustion chamber via an inflow line (FIG. 1). Hot exhaust gases are conducted from the combustion chamber via a line 20 into the interior of a rotating drum-like apparatus 3a, for example a rotary drum. In the apparatus 3a, road debris material, in particular material containing polycyclic hydrocarbons, which is fed into the apparatus 3a via a feed line or conveyor 3, is exposed to the hot exhaust gases, preferably reaching temperatures of up to 400° C. Via a line 4, for example a closed pipe with a conveyor or a chute, the heated material is fed to a silo 4a, which serves as an intermediate storage and comprises, for example, an electric trace heating or a hot gas jacket heating. From the silo 4a, the material passes into a mixer 5, which is connected via a line 10 to a device 8 for generating a negative pressure and in which a negative pressure can be generated by means of the device 8. A condenser, a heat exchanger and a pump are connected to the device 8. The condenser stores, for example, a fluid medium, such as an oil like fuel oil, in which hydrocarbons extractable from the road construction material are soluble, emulsifiable or suspendable. A negative pressure is preferably generated in the device 8 by means of a jet pump operated with the oil. Under the negative pressure, the oil absorbs hydrocarbons from the road demolition material. At the same time, the heat exchanger serves to heat or cool the oil of the device 8; advantageously, the heat exchanger 8 serves to regulate the oil temperature to an optimal temperature.

Via a line 12, the heat exchanger is connected to a tank 12a, which serves as a buffer tank. This is connected to the burner 1 via a pump 12b; in this way, oil containing hydrocarbons from the material heated in the rotating drum-like apparatus 3a and the silo 4a or the mixer 5 can be burned in the combustion chamber 1 so that the tar contained in the material is completely disposed of. Alternatively or additionally, the device 8 is connected to the burner 1 via a direct line 11 so that combustible gas loaded with PAHs is introduced into the burner 1. The device 8, for example a liquid jet pump, has a heat exchanger. Instead of the liquid jet pump, another vacuum generator may be provided.

From the mixer 5, part of the material or all of the material cleaned of PAHs can be fed to a silo 5b. From there it can be transferred to a cooling apparatus 6. From this cooling apparatus 6 it is then fed to a stockpile for temporary storage before being used again for road construction.

From the apparatus 3a, together with a first fraction of the hydrocarbon-containing hot gases 9 escaping from the road construction material under the influence of the temperature applied therein (and a negative pressure that can already be applied in the apparatus 3a), are passed via a device 9a for preliminary dedusting and to a device 9b for thermal and/or catalytic aftertreatment. Their exhaust gases are passed via a line 13 to a heat exchanger 13a, which transfers its heat to the ambient air, which is supplied via a line 17 and a fan 17a, and exhaust gases are passed via a line 14 to a further device 14a for dedusting and aftertreatment of the exhaust air.

From this, the exhaust gas is passed via a line 14b and a fan 14c to a chimney 14d. From the heat exchanger 13a, preheated secondary air 19 is conducted via a line to the combustion chamber 1 as well as to the combustion apparatus 2.

The directly heated apparatus 3a is preferably operated in co-current to avoid condensation problems. The apparatus 3a may additionally be equipped with internal conveying elements, for example screw internals, spiral blades or lifting blades. In addition, a weir can also be provided inside the apparatus 3a to influence the degree of filling and the residence time of the material to be treated.

The embodiment of the plant shown in FIG. 2 differs from the embodiment shown in FIG. 1 in that no device 9a for preliminary dedusting is provided downstream of a rotating drum-type apparatus 3b.

Apparatus 3b according to FIG. 2 has indirect heating by means of a double jacket 3b′, to which exhaust gases are fed via line 20. However, this does not preclude the additional or alternative introduction of exhaust gases into the interior of the apparatus 3b. Exhaust gases escaping from the apparatus 3b can be fed to the combustion device.

Hot gases 9 escaping from the double jacket 3b′ are passed to a heat exchanger 13a, which transfers its heat to the ambient air, which is supplied via a line 17 and a fan 17a, and exhaust gases are passed via a line 14 to a further unit 14a for dedusting and after-treatment of the exhaust air. From this, the exhaust gas is passed via a line 14b and a fan 14c to a chimney 14d. From the heat exchanger 13a, preheated secondary air is fed to the combustion chamber 1 via a line 19.

In another embodiment (FIG. 3), two or more rotary kilns 3c, 3d are operated alternately or in parallel. They are heated either indirectly, as shown in FIG. 3, or directly. In all other respects, the embodiment according to FIG. 3 is comparable to that shown in FIG. 2.

In contrast to the apparatus 3a (FIG. 1), the apparatus 3b (FIG. 2) must be heated with higher temperatures, since the heating is carried out indirectly via the double jacket 3b′. The disadvantage of indirectly heated apparatus is generally that high temperatures must be applied outside the shell to allow sufficient heat flow. This requires the use of high-grade steels, and in addition, the jacket exterior must also be sealed off from the surroundings. If a negative pressure is generated within the apparatus 3b, it is added that the shell 3b′ must withstand the negative pressure of the vacuum and, moreover, should still allow the introduction of process vapors or gases.

The apparatus 3a, 3b or the apparatuses 3c, 3d are followed by apparatuses for the reduction of emissions, in particular for thermal and/or catalytic after-treatment.

In order to ensure the transition to batchwise operation, the heated material discharged from the apparatus 3a, 3b or the rotary kilns 3c, 3d is fed into an insulated storage silo 4, which may be heated and kept under atmospheric or low negative pressure.

From the silo 4, the heated material is discharged into one or more insulated containers, optionally heated, where it is evacuated at a pressure of from 1 to 600 mbar, preferably from 20 to 100 mbar, to completely remove polycyclic hydrocarbons and other undesirable compounds of carbon contained in the material, or at least to the extent required by applicable regulatory limits.

The residence time can also be varied for process optimization. For example, times of 10 to 90 minutes are envisaged.

The vessels such as the silos and the mixer or the circulator preferably operate in batch mode, which facilitates the provision of the vacuum.

Each of the bins or the silo 4 or the mixer 5 can be preheated by means of a burner (or an electrical heat tracing) to avoid a drop in temperature of the material during start-up or to maintain or, if necessary, increase it during operation. The mineral present in the bins is agitated by moving devices, e.g. by rotating bins, or by internal rotating conveying/mixing devices, to expose the surface of the bulk material for degassing and to avoid caking.

An intermittent admixture of preferably preheated gases or vapors is also possible to actively expel or flush out the gaseous PAHs. For example, gaseous nitrogen is introduced into the rotating drum-type apparatus. In batch operation, the apparatus can be operated in such a way that a vacuum is first generated to remove at least low-boiling hydrocarbons from the break-up material. The pressure is then raised again to approximately atmospheric pressure by means of an inert gas, in particular nitrogen or carbon dioxide or ambient air or air with an increased content of nitrogen and/or carbon dioxide, and the mixture of these gases with the hydrocarbons dissolved in them is fed to a burner and burned therein. The use of nitrogen, argon and/or carbon dioxide may be necessary to prevent the possibility of spontaneous ignition of the gaseous hydrocarbons after the apparatus has been heated. Exhaust gas after-treatment systems are installed upstream or downstream of the burner to remove dusts and/or reduce nitrogen oxides and the like produced by combustion. Preferably, filter systems are equipped with appropriate catalysts.

A corresponding arrangement is also possible in conjunction with a container which is preferably also heated and/or operated at a negative pressure, in which case the negative pressure applied is preferably below the negative pressure used in the apparatus upstream of the at least one container. Also in this case, heavy-boiling hydrocarbons escape into the gas phase from the break-up material temporarily stored in the vessel. An inert gas or gas mixture is then supplied to further prevent ignition of the hydrocarbons dissolved in the gas phase. Then the gaseous hydrocarbons are fed to a burner, which in particular may be the same burner as the burner heating the at least one rotating drum-type apparatus. Also in this case, an exhaust gas after-treatment is preferably provided.

The hydrocarbons escaping from the material may also be cracked, for example. This is understood to mean a material transformation or conversion by which medium- and long-chain hydrocarbons are split into short-chain hydrocarbons. Both thermal cracking and catalytic cracking are suitable.

Preferably, the hydrocarbons recovered from the road debris are reused in the heating process to heat the at least one rotating drum-like apparatus and/or the at least one downstream container or to support these heating processes.

The product discharged from silo 5, once sufficiently cooled, is available for further use in the asphalt mixing plant. The vacuum in silos 4, 5 is generated, for example, by a downstream vacuum unit.

The setup of a plant for removing PAHs from road excavation material shown in FIG. 4 differs from the setups shown in FIG. 1 and FIG. 3 in that, according to FIG. 4, two units 3a, 3b are connected in series. Otherwise, the same units are provided as shown according to the other embodiment examples.

The separated gaseous PAHs are condensed, preferably with the aid of commercially available liquid jet vacuum pumps, in a circulating stream of water, water vapor, another vapor, from a liquid hydrocarbon or hydrocarbon mixture such as fuel oil or another combustible fluid as a propellant, and are preferably emulsified or suspended at the same time. A partial stream is thereby separated and can subsequently be utilized as fuel. The fuel oil as the propellant in the vacuum pump can be either cooled or heated, for example to achieve its optimum function in vacuum generation.

If water is used as the propellant for the jet pump (water jet pump), the hydrocarbons that have escaped from the broken-up material and are dissolved or emulsified or suspended in the water are then separated from the water again by a centrifuge or other thermal or mechanical separator. In this case, the water can be used in a closed circuit.

According to the invention, a jet pump, also referred to as an ejector or aspirator, is preferably used, which generates a negative pressure, i.e. has a predominantly suction effect. According to the invention, the jet pump can simultaneously be designed as a burner, for example as a Bunsen burner, which is used elsewhere in the entire system for at least partial heating of a unit belonging to the system, such as the at least apparatus. The jet pump thus also has an overall venting function for the aggregates of the plant. Each individual aggregate of the plant, such as the at least one mixer or the at least one vessel, is preferably connected to a jet pump to remove gaseous dissolved hydrocarbons. Either the jet pump is already sufficient to generate the negative pressure required in the respective aggregate sufficient to remove a sufficient percentage of PAHs from the break-up material, or another pump is provided to generate the required negative pressure.

Either one liquid jet pump is already sufficient to generate the negative pressure required in a rotating drum-like apparatus according to the invention and/or a container, such as a silo or a mixer, or several liquid jet pumps are used; likewise, a combination of different processs for generating a negative pressure is possible, for example with the use of vacuum pumps.

For example, the separated PAHs and gaseous fluids can be fed directly to a thermal afterburner via a vacuum pump.

At individual units of the plants shown in FIGS. 1 to 4, waste heat, for example from exhaust air, can be used for combustion air preheating (indirectly) or for direct asphalt preheating.

The exhaust air generated during combustion is dedusted in various plants, such as plants 9a, 14a; alternatively and/or additionally, nitrogen oxides and/or sulfur oxides are removed, in particular catalytically.

According to the invention, it is also possible to provide for the use of an inert gas, for example to purge with it the mixer 5 or a furnace such as one of the rotary kilns 3a, 3b, 3c, 3d, for example intermittently to drive out the PAHs, or as an active gas to strip hydrocarbons, ie, physically separating them from a liquid phase by desorption processes (utilizing Henry's law) into the gaseous phase, or to crack them in order to achieve the simplest possible separation of the PAHs in this way.

1-17. (canceled)

18. A method for treating a mineral solids mixture containing impurities with aromatic and/or aliphatic hydrocarbons, wherein the solids mixture is heated to a temperature below 570° C.,
wherein that the solids mixture is heated in at least one rotating drum-like apparatus and is passed through at least one container and that the solids mixture is subjected to a negative pressure during heating or after heating and that the hydrocarbons are extracted from the heated solids mixture.

19. The method according to claim 18, wherein
the solid mixture is heated after passing through the at least one apparatus or that at least the temperature of the solid mixture is maintained.

20. The method according to claim 18, wherein the mixture of solids in the container is heated a further time after passing through the at least one apparatus or at least the temperature of the mixture of solids is maintained.

21. The method according to claim 18, wherein the mixture of solids passes through the at least one apparatus at negative pressure.

22. The method according to claim 18, wherein the solids mixture passes through the container at a negative pressure.

23. The method according to claim 18, wherein at least low-boiling hydrocarbons are extracted from the solids mixture as gases.

24. The method according to claim 18, wherein high-boiling hydrocarbons are extracted from the solid mixture after passing through the at least one apparatus in the vessel, or in a silo or apparatus with active or passive agitation of the material.

25. The method according to claim 24, wherein the hydrocarbons are fed to a condenser.

26. The process according to claim 25,wherein the jet of the jet scrubber or of a vacuum pump is formed by water or a combustible fluid, in which the high-boiling hydrocarbons are dissolved or emulsified or suspended during the washing process.

27. The method according to claim 26, wherein the fluid, together with the hydrocarbons dissolved in it, is fed to a burner which heats the at least one apparatus and/or the container.

28. The method according to claim 26, wherein the waste gas produced during combustion in the burner is directed into the interior of the at least one apparatus and/or of the container and/or heats the apparatus and the container from the outside.

29. A plant for processing a mineral solid mixture containing impurities with aromatic and/or aliphatic hydrocarbons, with a burning device for heating the solid mixture to a temperature below 570° C., wherein the plant comprises at least one heated rotating drum-like apparatus and at least one container arranged downstream of the at least one apparatus in the transport direction of the solids mixture, as well as an arrangement for generating a negative pressure, and in that the solids mixture can be exposed to the negative pressure during heating or after heating.

30. The plant according to claim 29, wherein the combustion apparatus comprises at least one first burner, and in that hydrocarbons heated in the at least one apparatus and converted into the gaseous state can be fed to at least the first burner and/or to a further burner.

31. The plant according to claim 29, wherein hydrocarbons heated and/or emulsified or suspended in a fluid in the at least one container, can be fed to the first burner and/or the second burner.

32. The plant according to claim 31, wherein a device for generating a negative pressure is connected to the mixer.

33. The plant according to claim 32, wherein a condenser, a heat exchanger and a pump are connected to the device.

34. The plant according to claim 33, wherein the pump is a vacuum pump or a jet pump or a liquid jet pump or a water jet pump.

35. The plant according to claim 30, wherein the plant comprises at least one arrangement for dedusting the gaseous hydrocarbons escaping from the at least one apparatus.

36. The plant according to claim 29, wherein a jet scrubber for removing gaseous hydrocarbons is arranged downstream of the apparatus.

37. The plant according to claim 29, wherein at least two apparatuses are connected in series.
